(19) United States
(12) Patent Application Publication
(10) Pub. No.: US 2025/0165214 A1
(43) Pub. Date: May 22, 2025

(54) INFORMATION PRESENTATION APPARATUS AND NON-TRANSITORY COMPUTER READABLE MEDIUM

(71) Applicant: TOYOTA JIDOSHA KABUSHIKI KAISHA, Toyota-shi (JP)

(72) Inventors: Yu NAGATA, Tokyo-to (JP); Ryota YANAGISAWA, Tokyo-to (JP); Akira MIYAMOTO, Nisshin-shi (JP); Eiichi MAEDA, Asaka-shi (JP); Haruto TOYAMA, Nagoya-shi (JP); Kotaro HIROSE, Nisshin-shi (JP); Yasuhiro KOBATAKE, Nagoya-shi (JP); Kazunori WATANABE, Okazaki-shi (JP)

(73) Assignee: TOYOTA JIDOSHA KABUSHIKI KAISHA, Toyota-shi (JP)

(21) Appl. No.: 18/929,612

(22) Filed: Oct. 29, 2024

(30) Foreign Application Priority Data
Nov. 21, 2023 (JP) 2023-197755

(51) Int. Cl. G06F 3/16

(52) U.S. Cl. CPC G06F 3/167

(57) ABSTRACT

An information presentation apparatus includes a controller configured to display on screen, upon detecting presence of information related to a destination when the destination is set by an occupant of a vehicle, a banner notifying the occupant of the information related to the destination, the controller saving a notification made by the banner according to voice input from the occupant.

### CROSS-REFERENCE TO RELATED APPLICATION

This application claims priority to Japanese Patent Application No. 2023-197755 filed on Nov. 21, 2023, the entire contents of which are incorporated herein by reference.

### TECHNICAL FIELD

The present disclosure relates to an information presentation apparatus and a program.

### BACKGROUND

Patent Literature (PTL) 1 discloses an information display apparatus that displays, on a navigation system, various information about locations around a route to a destination.

### CITATION LIST

### Patent Literature

PTL 1: JP 2004-257951 A

### SUMMARY

It is difficult for drivers to fully understand the various information displayed on the navigation system while driving.

It would be helpful to make it easier for an occupant to view information related to the destination, which is notified to the occupant on the screen in a vehicle.

An information presentation apparatus according to the present disclosure includes a controller configured to display on screen, upon detecting presence of information related to a destination when the destination is set by an occupant of a vehicle, a banner notifying the occupant of the information related to the destination, the controller saving a notification made by the banner according to voice input from the occupant.

A program according to the present disclosure causes a computer to execute operations, the computer displaying on screen, upon detecting presence of information related to a destination when the destination is set by an occupant of a vehicle, a banner notifying the occupant of the information related to the destination, the operations including saving a notification made by the banner according to voice input from the occupant.

According to the present disclosure, it is possible for an occupant of a vehicle to save notifications made by banners and view information related to the destination at a later time. Therefore, it is easier for the occupant to view the information related to the destination, which is notified to the occupant on the screen in the vehicle.

### BRIEF DESCRIPTION OF THE DRAWINGS

In the accompanying drawings:

FIG. 1 is a diagram illustrating a configuration of a system according to an embodiment of the present disclosure;

FIG. 2 is a diagram illustrating a screen example of an information presentation apparatus according to the embodiment of the present disclosure;

FIG. 3 is a block diagram illustrating a configuration of the information presentation apparatus according to the embodiment of the present disclosure; and

FIG. 4 is a flowchart illustrating operations of the information presentation apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

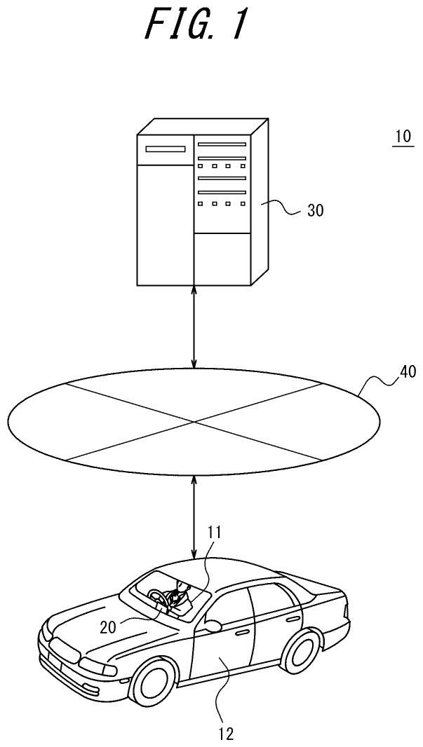

A configuration of a system 10 according to the present embodiment will be described with reference to FIG. 1.

The system 10 according to the present embodiment includes an information presentation apparatus 20 and a server apparatus 30. The information presentation apparatus 20 can communicate with the server apparatus 30 via a network 40.

The information presentation apparatus 20 is a computer with voice recognition capability. The information presentation apparatus 20 is an in-vehicle device, such as a navigation device, installed in a vehicle 12. Alternatively, the information presentation apparatus 20 may be a mobile device, such as a mobile phone, a smartphone, or a tablet, owned by a user 11. The information presentation apparatus 20 is used by the user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12, which is driven by a driver, may be automated at certain levels. The automation level is, for example, any one of Level 1 to Level 4 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

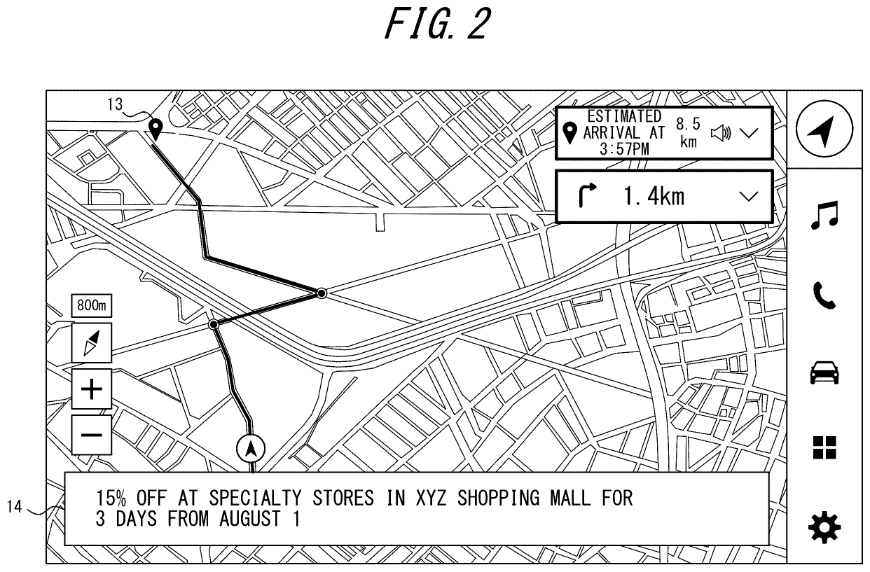

As in the example illustrated in FIG. 2, the information presentation apparatus 20 displays on screen, upon detecting presence of information related to a destination 13 when the destination 13 is set by the user 11, a banner 14 notifying the user 11 of the information related to the destination 13. The information presentation apparatus 20 saves a notification made by the banner 14 according to voice input from the user 11.

According to the present embodiment, it is possible for the user 11 to save the notification made by the banner 14 and view the information related to the destination 13 at a later time. Therefore, it is easier for the user 11 to view the information related to the destination 13, which is notified to the user 11 on the screen in the vehicle 12.

In particular, when the user 11 is a driver, even if the user 11 is notified of information related to the destination 13, it may be difficult for the user 11 to carefully view the information, such as while driving. However, the present embodiment allows the user 11 to view information related to the destination 13 at a convenient time, such as after arriving at the destination 13. Thus, the user 11 can fully understand the information related to the destination 13.

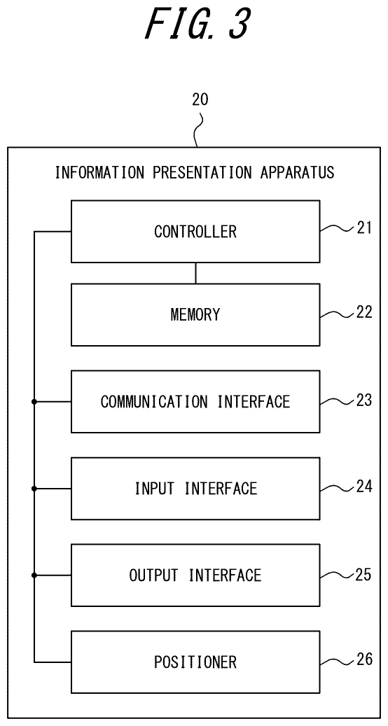

A configuration of the information presentation apparatus 20 according to the present embodiment will be described with reference to FIG. 3.

The information presentation apparatus 20 includes a controller 21, a memory 22, a communication interface 23, an input interface 24, an output interface 25, and a positioner 26.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the information presentation apparatus 20 while controlling components of the information presentation apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the information presentation apparatus 20 and information obtained by the operations of the information presentation apparatus 20.

The communication interface 23 includes at least one communication module. The communication module is, for example, a module compatible with a mobile communication standard such as LTE, the 4G standard, or the 5G standard, a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives information to be used for the operations of the information presentation apparatus 20, and transmits information obtained by the operations of the information presentation apparatus 20.

The input interface 24 includes at least one input device. The input device is, for example, a physical key, a capacitive key, a pointing device, a touch screen integrally provided with a display, a visible light camera, a LiDAR sensor, or a microphone. The term “LiDAR” is an abbreviation of light detection and ranging. The input interface 24 accepts an operation for inputting information to be used for the operations of the information presentation apparatus 20. The input interface 24, instead of being included in the information presentation apparatus 20, may be connected to the information presentation apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs information obtained by the operations of the information presentation apparatus 20. The output interface 25, instead of being included in the information presentation apparatus 20, may be connected to the information presentation apparatus 20 as an external output device such as a display audio. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 26 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 26 measures the position of the information presentation apparatus 20.

The functions of the information presentation apparatus 20 are realized by execution of a program according to the present embodiment by a processor serving as the controller 21. That is, the functions of the information presentation apparatus 20 are realized by software. The program causes a computer to execute the operations of the information presentation apparatus 20, thereby causing the computer to function as the information presentation apparatus 20. That is, the computer executes the operations of the information presentation apparatus 20 in accordance with the program to thereby function as the information presentation apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information presentation apparatus 20 may be realized by a programmable circuit or a dedicated circuit serving as the controller 21. That is, some or all of the functions of the information presentation apparatus 20 may be realized by hardware.

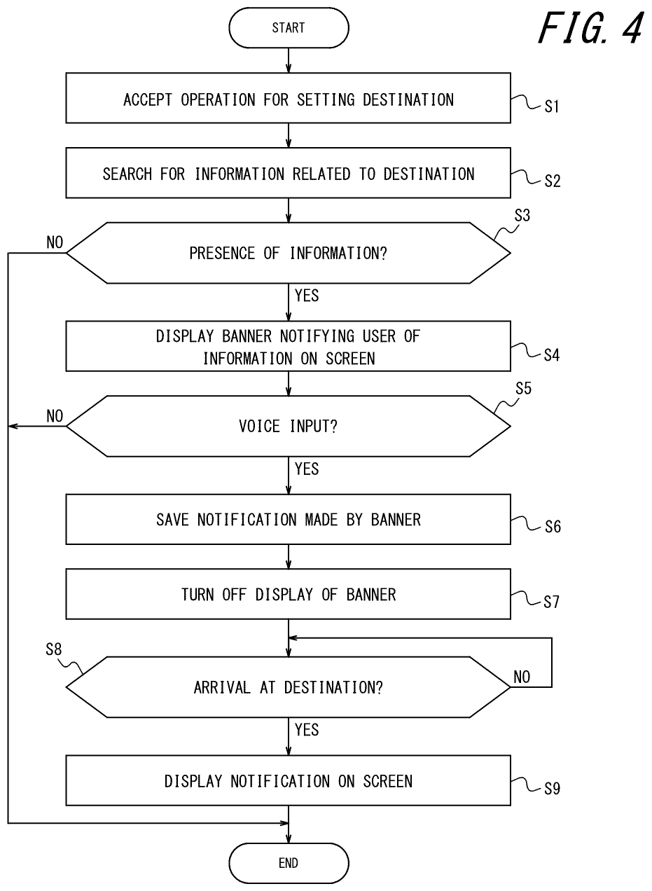

Operations of the information presentation apparatus 20 according to the present embodiment will be described with reference to FIG. 4. The operations described below correspond to an information presentation method according to the present embodiment. In other words, the information presentation method according to the present embodiment includes steps S1 through S9 illustrated in FIG. 4.

In S1, the controller 21 accepts an operation by the user 11 to set a destination 13 via the input interface 24. Specifically, the controller 21 recognizes voice input from the user 11 specifying a location via a microphone as the input interface 24. Alternatively, the controller 21 may display a list of candidate destinations on a display as the output interface 25 and recognize touch input by the user 11 to select a location from the displayed list via a touch screen as the input interface 24. The controller 21 sets the designated or selected location as the destination 13. The controller 21 then searches for a route to the set the destination 13 and starts navigation along the route by referring to the map database that is built in the memory 22 or in an external storage accessible via the communication interface 23. For example, upon recognizing the utterance “I want to go to XYZ Shopping Mall” or a tap on the destination candidate “XYZ Shopping Mall”, the controller 21 sets XYZ Shopping Mall as the destination 13, searches for a route to XYZ Shopping Mall, and starts navigation.

In S2, the controller 21 searches for information related to the destination 13 set in S1. Specifically, the controller 21 searches the web or the cloud via the communication interface 23 for content, such as a home page, that introduces the destination 13 as information related to the destination 13. Alternatively, the controller 21 may search the web or the cloud via the communication interface 23 for coupons or admission tickets or other tickets that can be used at facilities located at the destination 13 as information related to the destination 13. For example, the controller 21 searches for coupons that can be used on the XYZ Shopping Mall website or at stores in XYZ Shopping Mall.

In S3, the controller 21 determines whether or not information related to the destination 13 exists according to the results of the search in S2. If it is determined that information related to the destination 13 is present, such as content that introduces the destination 13 or tickets that can be used at facilities located at the destination 13, i.e., the presence of information related to the destination 13 is detected, step S4 is executed. For example, if a coupon is found that can be used on the XYZ Shopping Mall website or at a store in XYZ Shopping Mall, step S4 is executed. On the other hand, if it is determined that there is no information related to the destination 13, i.e., the presence of information related to the destination 13 is not detected, the flow illustrated in FIG. 4 ends.

In S4, the controller 21 displays a banner 14 notifying the user 11 of the information related to the destination 13 on screen. Specifically, as in the example illustrated in FIG. 2, the controller 21 displays an area as the banner 14 on the display as the output interface 25 that encourages the user 11 to view content introducing the destination 13. For example, the controller 21 displays a notification “15% off at specialty stores in XYZ Shopping Mall for 3 days from August 1” on screen. The banner 14 has a link to content that introduces the destination 13. Therefore, when the controller 21 recognizes the touch input by the user 11 to the banner 14 via the touch screen as the input interface 24, it displays on the display content introducing the destination 13, such as the home page of XYZ Shopping Mall. Alternatively, the controller 21 may display an area on the display as the banner 14 that encourages the user 11 to visit a facility at the destination 13 and use a ticket that can be used at that facility. For example, the controller 21 may display a notification “There are coupons that can be used at specialty stores. Would you like to visit a specialty store?” on screen.

In S5, the controller 21 waits for a certain period of time until it recognizes a voice input from the user 11 requesting to save the notification made by the banner 14 displayed on screen in S4 via the microphone as the input interface 24. For example, the controller 21 waits until it recognizes the utterance “KEEP”. If a voice input requesting to save the notification is recognized within a certain time period, step S6 is executed. On the other hand, if a voice input requesting the storage of a notification is not recognized within a certain period of time, the flow illustrated in FIG. 4 ends. Alternatively, when a voice input requesting deletion of the notification, such as the utterance “unnecessary”, is recognized, the flow illustrated in FIG. 4 may end after step S6 is executed.

In S6, the controller 21 saves the notification made by the banner 14 according to the voice input recognized in S5. Specifically, the controller 21 stores temporary storage data in the memory 22 to redisplay the area displayed as the banner 14 in S4. For example, the controller 21 saves the notification “15% off at specialty stores in XYZ Shopping Mall for 3 days from August 1” with the link as a bookmark. Alternatively, the controller 21 may save the notification “There are coupons that can be used at specialty stores. Would you like to visit a specialty store?” as a bookmark. These bookmarks differ from general “favorites” in that they are temporarily saved for later viewing that the user 11 cannot see now.

In S7, the controller 21 turns off the display of the banner 14.

In S8, the controller 21 determines whether the vehicle 12 has arrived at the destination 13. Specifically, the controller 21 determines that the vehicle 12 has arrived at the destination 13 when the position of the information presentation apparatus 20 measured by the positioner 26 matches the destination 13 set in S1. The controller 21 determines that the vehicle 12 has not arrived at the destination 13 when the position of the information presentation apparatus 20 measured by the positioner 26 does not match the destination 13 set in S1. In a case in which it is determined that the vehicle 12 has arrived at the destination 13, step S9 is executed. On the other hand, if it is determined that the vehicle 12 has not arrived at the destination 13, step S8 is executed again.

In S9, the controller 21 displays the notification saved in S6 on screen. Specifically, the controller 21 refers to temporarily stored data stored in the memory 22 and redisplays the area that encourages the user 11 to view content introducing the destination 13 as the banner 14 on the display as the output interface 25. For example, the controller 21 displays the notification “15% off at specialty stores in XYZ Shopping Mall for 3 days from August 1”, saved as a bookmark, on screen with a link. When the controller 21 recognizes the touch input by the user 11 to the banner 14 via the touch screen as the input interface 24, it displays on the display content introducing the destination 13, such as the home page of XYZ Shopping Mall. Alternatively, the controller 21 may refer to the data stored in the memory 22 and redisplay an area on the display encouraging the user 11 to visit the facility at the destination 13 and use the coupons available at that facility. For example, the controller 21 may display the notification “There are coupons that can be used at specialty stores. Would you like to visit a specialty store?”, saved as a bookmark, on screen. After S9, the flow illustrated in FIG. 4 ends.

In the case of displaying a plurality of banners on screen, the controller 21 may transmit, as its result, statistical data regarding notifications that have been saved according to voice input from the user 11 and notifications that have not been saved, among notifications made by the plurality of banners, to the server apparatus 30 via the communication interface 23. In such instances, the server apparatus 30 instructs the information presentation apparatus 20 to reduce the frequency of displaying unpopular notifications that were not saved the next time around. This example provides feedback to content providers regarding statistics on popular and unpopular content, and allows them to optimize banner display by, for example, reducing the frequency of display of unpopular content from the next time onward.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

1. An information presentation apparatus comprising a controller configured to display on screen, upon detecting presence of information related to a destination when the destination is set by an occupant of a vehicle, a banner notifying the occupant of the information related to the destination, the controller saving a notification made by the banner according to voice input from the occupant.

2. The information presentation apparatus according to claim 1, wherein the controller is configured to turn off display of the banner in saving the notification made by the banner.

3. The information presentation apparatus according to claim 1, wherein the controller is configured to display the saved notification on screen upon determining that the vehicle has arrived at the destination.

4. The information presentation apparatus according to claim 1, further comprising a communication interface configured to communicate with a server apparatus,
wherein the controller is configured to transmit, as a result of displaying a plurality of banners on screen, statistical data regarding notifications that have been saved according to the voice input and notifications that have not been saved, among notifications made by the plurality of banners, to the server apparatus via the communication interface.

5. A non-transitory computer readable medium storing a program configured to cause a computer to execute operations, the computer displaying on screen, upon detecting presence of information related to a destination when the destination is set by an occupant of a vehicle, a banner notifying the occupant of the information related to the destination, the operations including saving a notification made by the banner according to voice input from the occupant.
